(19) United States
(12) Patent Application Publication
(10) Pub. No.: US 2024/0092460 A1
(43) Pub. Date: Mar. 21, 2024

(54) BUOYANT OFFSHORE PLATFORM AND A METHOD OF DEPLOYING BUOYANT OFFSHORE PLATFORMS

(71) Applicant: Marine Power Systems Limited, Swansea South Wales (GB)

(72) Inventor: Graham FOSTER, Swansea South Wales (GB)

(73) Assignee: Marine Power Systems Limited, Swansea South Wales (GB)

(21) Appl. No.: 18/500,713

(22) Filed: Nov. 2, 2023

Related U.S. Application Data
(63) Continuation of application No. PCT/EP2022/062362, filed on May 6, 2022.

(30) Foreign Application Priority Data
May 7, 2021 (GB) 2106575.0
Mar. 18, 2022 (GB) 2203820.2

(51) Int. Cl. B63B 35/44; B63B 21/50; B63B 75/00

(52) U.S. Cl. CPC B63B 35/44; B63B 21/502; B63B 75/00; B63B 2035/446

(57) ABSTRACT

A buoyant offshore platform for supporting a renewable energy system having a base portion for submerging below the surface of a body of water, a top portion, at least one mooring line for fixing the platform to a bed of the body of water, and a tensioning means for applying tension to at least one of the mooring lines. The platform further comprises a floating configuration in which the platform is positioned floating on the surface of the body of water. The platform has a deployed configuration in which the base portion is submerged and the top portion remains above the surface of the body of water. In use, the tensioning means is arranged to apply tension to the at least one mooring line fixed between the platform and the bed such that the buoyant offshore platform transitions between the floating configuration and the deployed configuration.

### CROSS REFERENCE TO RELATED APPLICATIONS

This continuation application claims priority benefit from International Application No. PCT/EP2022/062362 filed on May 6, 2022, which claimed priority from Great Britain Application No. 2106575.0 filed May 7, 2021 and Great Britain Application No. 2203820.2 filed Mar. 18, 2022, which are all incorporated herein by reference in their entireties.

### FIELD OF THE INVENTION

The present disclosure relates to a buoyant offshore platform for supporting renewable energy systems, a tensioning means for deploying such a platform, and a method of deploying buoyant offshore platforms.

### BACKGROUND OF THE INVENTION

Wave energy and offshore wind energy have both been identified as leading technology options to decarbonise the global energy system. The economic viability and practical feasibility of these renewable energy systems are heavily reliant on the ease and cost of installation and maintenance of these systems offshore. One solution to minimise the costs of these systems is to install the wave energy and wind energy systems offshore on floating or buoyant platforms.

Buoyant offshore platforms are beneficial in that the foundations required for a buoyant offshore platform are typically quicker and easy to install on the bed of the body of water, and the foundations can be more easily laid at greater depths. Furthermore, a complete buoyant offshore platform may be manufactured on or adjacent to land and can then be towed out to the desired location rather than assembled offshore piece-by-piece. However, problems exist with current state-of-the-art buoyant offshore platforms and with the methods and equipment used to install them offshore. Objects and aspects of the present disclosure seek to alleviate at least these problems with the prior art.

### SUMMARY OF THE INVENTION

The present disclosure is directed to a buoyant offshore platform for supporting a renewable energy system in a body of water, the platform having a submerged operating configuration in which a base portion thereof is submerged below a surface of said body of water, and a top portion thereof remains above said surface of said body of water. The top portion is preferably arranged to support a renewable energy system (which may, for example, comprise a wind turbine), a renewable energy storage device, and/or a compartment, building or room (which may, for example, be used to house or store platform control or maintenance equipment) above the surface of the body of water at all times in use. The platform of the disclosure comprises a tensioning means arranged to apply tension to one or more mooring lines in order to deploy the platform to the submerged operating configuration. In some preferable embodiments, the tensioning means is arranged to apply a first tensioning force to the one or more mooring lines such that the mooring lines become taut, and to subsequently provide a second tensioning force to the one or more mooring lines such that the platform is partially submerged in the body of water in the submerged operating configuration. In preferable embodiments, the second tensioning force is applied to said one or more mooring lines in a cyclic manner. Such a force is preferably provided by a reciprocating tensioning device having a one-way (unidirectional) mode arranged to engage the one or more mooring lines such that movement thereof is restricted to a single direction. Such one-way (unidirectional) movement may be provided, for example, by a pawl member of the reciprocating tensioning device, the pawl member being arranged to be moved by the tensioning device in a reciprocating manner such that the one or more mooring lines is moved by the pawl member in the single direction. An example such a pawl member, in an embodiment wherein the one or more mooring lines comprises a chain, may include a chain stopper. In particular examples, the reciprocating tensioning device is arranged to apply the second tensioning force to two such mooring lines, and in some embodiments may be arranged to apply the second tensioning force to one of the two mooring lines independently of the other of the two mooring lines. The present disclosure is further directed to a said reciprocating tensioning device for use with a buoyant offshore platform, a kit of parts comprising a said platform and a said tensioning device, and a method of deploying a said platform to the submerged operating configuration.

In accordance with an aspect of the present disclosure, there is provided a buoyant offshore platform for supporting a renewable energy system in a body of water having a surface and a bed, said buoyant offshore platform comprising: a base portion for submerging below said surface of said body of water; a top portion for remaining above said surface of said body of water; one or more mooring lines for fixing the buoyant offshore platform to said bed of said body of water; and a tensioning means for applying tension to the one or more mooring lines; wherein the buoyant offshore platform further comprises a floating configuration in which the buoyant offshore platform is positioned substantially floating on said surface of said body of water; wherein the buoyant offshore platform comprises a deployed configuration in which the base portion is submerged beneath said surface of said body of water and the top portion remains above said surface of said body of water; and further wherein, in use, the tensioning means is arranged to apply tension to the one or more mooring lines fixed between the buoyant offshore platform and said bed of said body of water such that the buoyant offshore platform transitions between the floating configuration and the deployed configuration.

In some embodiments, the tensioning means preferably comprises a pulley affixed to the platform, the pulley arranged to be driven by a drive means and further arranged to apply a first tensioning force to one or more said mooring lines when driven by the drive means.

In some embodiments, said tensioning means is preferably arranged to apply the first tensioning force to two said mooring lines.

In some embodiments, the platform preferably further comprises a mooring line storage compartment, and wherein the pulley is further arranged to direct said one or more mooring lines into the mooring line storage compartment.

In some embodiments, the mooring line storage compartment is preferably located within a hollow structural element of the top portion.

In some embodiments, the pulley is preferably permanently affixed to the platform.

In some embodiments, the drive means is preferably a motor, and wherein the motor is in removable engagement with the pulley.

In some embodiments, the tensioning means preferably further comprises a static unidirectional mechanism having a tensioning mode in which the unidirectional mechanism is arranged to restrict movement of one or more said mooring lines to a single direction; and a release mode in which the unidirectional mechanism is arranged to permit free movement of said mooring lines in any direction.

In some embodiments, the static unidirectional mechanism is preferably permanently affixed to the platform such that the static unidirectional mechanism is immovable relative to the platform.

In some embodiments the tensioning means preferably comprises an elongate rail arranged to be affixed to the platform, wherein the static unidirectional mechanism is positioned on the rail and arranged to move along the rail. Preferably, during the tensioning mode, the unidirectional mechanism is arranged to move along the rail from a slack position to a tensioning position, wherein during said movement, the tension is applied to the one or more mooring lines fixed between the buoyant offshore platform and said bed of said body of water such that the buoyant offshore platform transitions between the floating configuration and the deployed configuration.

In some embodiments, the tensioning means preferably further comprises a reciprocating unidirectional mechanism, the reciprocating unidirectional mechanism comprising: a first hydraulic ram and a second hydraulic ram, each of said first and second hydraulic rams affixed to a corresponding moveable unidirectional member having: a tensioning mode in which the unidirectional member is arranged to restrict movement of one of said mooring lines to a first direction, and further arranged to be moved by the corresponding hydraulic ram in the first direction to apply a second tensioning force to said mooring line; and a release mode in which the unidirectional member is arranged to be moved along said mooring line in a second direction opposing the first direction by the corresponding hydraulic ram; wherein each said unidirectional member is arranged to transition between the tensioning mode and the release mode in a reciprocating manner.

In some embodiments, each said unidirectional member may preferably be moved by the corresponding first or second hydraulic ram independently of the other unidirectional member.

In some embodiments, the one or more mooring lines preferably comprise a chain, and wherein the reciprocating unidirectional mechanism is a chain jack.

In some embodiments, the reciprocating unidirectional mechanism is preferably removably affixed to the platform.

In some embodiments, the tensioning means preferably further comprises an elongate rail, the reciprocating unidirectional mechanism positioned on the rail and arranged to move along the rail. In such embodiments, during the tensioning mode the reciprocating unidirectional mechanism is preferably arranged to move along the rail from a slack position to a tensioning position, wherein during said movement, the tension is applied to the one or more mooring lines fixed between the buoyant offshore platform and said bed of said body of water such that the buoyant offshore platform transitions between the floating configuration and the deployed configuration.

In preferable embodiments, the rail and the reciprocating unidirectional mechanism are removably affixed to the platform. Embodiments will be appreciated wherein the rail and the reciprocating unidirectional mechanism are permanently affixed to the platform. In preferable embodiments, the rail is an indexed rail or slotted rail have slots or grooves arranged to accept engagement by complimentary teeth members of the reciprocating unidirectional mechanism, said teeth members permitting movement of the reciprocating unidirectional mechanism along the rail. Preferably said teeth members are positioned on wheels or gears arranged to be driven by a motor of the reciprocating unidirectional mechanism. Features described as being suitable for use with the reciprocating unidirectional mechanism will be appreciated as being suitable also for the static unidirectional mechanism.

In some embodiments, the platform preferably further comprises a power line arranged to transmit power to and from the platform when the power line is in operative engagement with the platform, wherein the power line is arranged to be moved into operative engagement with the platform by the tensioning means.

In accordance with a further aspect of the present disclosure, there is provided a reciprocating unidirectional mechanism arranged to apply a tensioning force to two mooring lines of a platform in as claimed in any one of the preceding claims, the unidirectional mechanism comprising: a first hydraulic ram and a second hydraulic ram, each of said first and second hydraulic rams affixed to a corresponding moveable unidirectional member having: a tensioning mode in which the unidirectional member is arranged to restrict movement of one of said mooring lines to a first direction, and further arranged to be moved by the corresponding hydraulic ram in the first direction to apply a tensioning force to said mooring line; and a release mode in which the unidirectional member is arranged to be moved along said mooring line in a second direction opposing the first direction by the corresponding hydraulic ram.

In some embodiments, the reciprocating unidirectional mechanism is preferably arranged to apply the tensioning force to said two mooring lines independently of one another.

In some embodiments, the reciprocating unidirectional mechanism is a chain jack.

In some embodiments, the reciprocating unidirectional mechanism may be affixed to a rail and arranged to move along said rail as described herein.

In accordance with a further aspect of the present disclosure, there is provided a kit of parts comprising: a buoyant offshore platform in accordance with an aspect of the present disclosure; and a reciprocating unidirectional mechanism in accordance with an aspect of the present disclosure.

In accordance with a further aspect of the present disclosure, there is provided a method of deploying a buoyant offshore platform for supporting a renewable energy system, the method comprising: moving a buoyant offshore platform along a surface of a body of water to a location; fixing one or more mooring lines to the bed of the body of water; attaching the buoyant offshore platform to the one or more mooring lines via a tensioning means; applying a first tensioning force to the one or more mooring lines using the tensioning means, such that the one or more mooring lines become taut; applying a second tensioning force to the one or more mooring lines such that a portion of the buoyant offshore platform becomes submerged in the body of water.

In some embodiments, the method preferably comprises the additional step of: affixing a reciprocating unidirectional mechanism to the platform; wherein the second tensioning force is applied using the reciprocating unidirectional mechanism.

In some embodiments, the method preferably further comprises the additional step of: detaching the reciprocating unidirectional mechanism from the platform.

In accordance with a further aspect of the present disclosure there is provided a buoyant offshore platform for supporting a renewable energy system in a body of water having a surface and a bed, said buoyant offshore platform comprising:

a base portion for submerging below said surface of said body of water;

a top portion for remaining above said surface of said body of water;

one or more lines for fixing the buoyant offshore platform to said bed of said body of water; and

a tensioning means for applying tension to the one or more lines;

wherein the buoyant offshore platform comprises a deployed configuration in which the base portion is submerged beneath said surface of said body of water and the top portion remains above said surface of said body of water;

wherein the buoyant offshore platform further comprises a floating configuration in which the buoyant offshore platform substantially floats on said surface of said body of water; and

further wherein, in use, the tensioning means is arranged to apply tension to the one or more lines fixed between the buoyant offshore platform and said bed of said body of water such that the buoyant offshore platform transitions between the floating configuration and the deployed configuration.

In this way, there is provided a buoyant offshore platform which can be transported in its floating configuration to a predetermined site and then transitioned to its deployed configuration. Transporting the buoyant offshore platform in the floating configuration is advantageous as it reduces the drag or resistance of the buoyant offshore platform in the body of water.

In the deployed configuration, the buoyant offshore platform remains partially submerged as the one or more lines fixed between the bed of the body of the water and the buoyant offshore platform prevent the buoyant offshore platform from floating.

The buoyancy of the buoyant offshore platform acts in a substantially opposing direction to the direction that the lines are fixed between the offshore platform and the bed of the body of water. The opposing interplay of the buoyancy and the fixed one or more lines tightens the one or more lines. By tightening the one or more lines the buoyant offshore platform is stabilised in its deployed configuration. Accordingly, in the deployed configuration the movement of the buoyant offshore platform in all directions in the body of water should be substantially less than the movement of the buoyant offshore platform in the floating configuration on the body of water. The stabilisation of the buoyant offshore platform is key for many of its intended uses as it allows it to act as, for example, a stable offshore platform for supporting a wind turbine.

Preferably, in use, the one or more lines are fixed between the top portion of the buoyant offshore platform and said bed of said body of water. Fixing the line to the top portion of the buoyant offshore allows the affixment to be more easily adjusted or serviced as it is above the surface of the body of water.

Preferably, in use, the one or more lines are detachably attached to the buoyant offshore platform. In this way, the buoyant platform can be released from the line to easily transition the buoyant offshore platform from its deployed configuration to its floating figuration.

Preferably, the offshore buoyant platform comprises a set of attachment points for the affixment of the one or more lines. Preferably, each attachment point in the set of attachment points are located at different predefined positions such that, in use, and in the deployed configuration, the proportion of the base portion submerged beneath said surface of said body of water is controlled by attaching the line to one of the attachment points in the set of attachment points. Preferably, each attachment point in the set of attachment points are located at different predefined positions for controlling the proportion of the base portion submerged in the deployed configuration. In this way, the one or more lines can be attached to different positions on the offshore buoyant platform. The different positions of the set of attachment points may affect the angle of the buoyant platform or the depth that it is submerged at. Additionally, the attachment points can be used to account for differences in the height of the bed of the body of water such that when the offshore platform is attached by two of more lines the offshore platform remains level.

Preferably, the buoyant offshore platform comprises one or more directing members located on the base portion, wherein a directing member is arranged to direct one of the lines of the one or more lines between the buoyant offshore platform and said bed of said body of water. The directing members change the angle or direction of the lines of the one or more lines. The directing member or members act to urge and to route the lines. Preferably, the directing members are guides which are tubular members, of any shape and size to accommodate the lines and the direction change required. Preferably, the directing members are fairleads.

Preferably, the buoyant offshore platform comprises a first directing member arranged to direct one of the lines of the one or more lines in a direction substantially horizontally parallel with the plane occupied by the base portion, and through which the base portion moves between a deployed and a floating position. Preferably, the first directing member is arranged to direct one of the lines of the one or more lines at a location intermediate the base portion and the top portion.

Preferably the buoyant offshore platform comprises a second directing member arranged to direct one of the lines of the one or more lines in a direction substantially perpendicular to the plane occupied by the base portion, and through which the base portion moves between a deployed and a floating position.

Preferably the buoyant offshore platform comprises a plurality of lines for fixing the buoyant offshore platform to said bed of said body of water. A plurality of lines builds redundancy and resilience into the system.

Preferably the buoyant offshore platform comprises a plurality of directing members, wherein each line of said plurality of lines is directed by at least one of the directing members of said plurality of directing members.

Preferably the tensioning means of the buoyant offshore platform is located on the top portion of the buoyant offshore platform. More preferably, the tensioning means comprises at least one or more winches.

Preferably the tensioning means of the buoyant offshore platform comprises a block and tackle. Preferably a single continuous rope around the block transmits the tensioning force around the block and pulleys and so provides tension between the lines as required. The pulley system of a block and tackle is advantageous in exerting the tensioning force as the pulleys exhibit a mechanical advantage and amplifying the force applied to the rope.

Preferably the buoyant offshore platform further comprises a crane arranged so as to move the tensioning means.

Preferably the buoyant offshore platform comprises an open framework. Such a framework of open areas and a lattice structure provides overall strength and robust construction suitable for withstanding impact, continual fluid flow and surge around the platform and any rough, stormy sea conditions.

In accordance with a further aspect of the disclosure, there is provided a kit of parts, the kit of parts comprising:

an offshore platform in accordance with an aspect of the disclosure; and

a winch for removably mounting at the top portion of the buoyant platform and detachably attaching to the line, such that, in use, the winch is arranged to submerge the base portion of the buoyant platform by winching the buoyant platform towards the bed of the body of water.

Preferably, the kit of parts further comprises a reeving pulley for acting on the line between the winch and the bed.

Preferably, the kit of parts further comprises a tensioning line for extending between the line and the winch.

In accordance with a further aspect of the present disclosure, there is provided a method of deploying an offshore platform for supporting renewable energy systems, the method comprising:

moving an offshore platform comprising a buoyant platform along a surface of a body of water to a location;

fixing a line to the bed of the body of water;

attaching the buoyant platform to the line via a winch or a tensioning means;

winching the buoyant platform relative to the line, such that a portion of the buoyant platform becomes submerged in the body of water and the winch or the tension means remains above the surface of the body of water.

Preferably, the method of deploying an offshore platform comprises the additional steps of:

disconnecting the line from the winch or the tensioning means; and

attaching the line to a portion of the offshore platform above the surface of the body of water, such that the offshore platform remains partially submerged in the body of water.

Preferably, the method of deploying an offshore platform comprises the additional step of:

directing the line extending between the winch or the tensioning means and bed of the body of water using guides located on the buoyant platform.

In preferable embodiments, the tensioning means is any suitable tensioning means as described herein.

In accordance with a further aspect of the present disclosure, there is provided a method of deploying an offshore platform for supporting renewable energy systems, the method comprising:

moving an offshore platform comprising a buoyant platform along a surface of a body of water to a desired deployment location;

connecting one or more installation lines between the platform and a corresponding anchor affixed to a bed of the body of water;

applying a tension to the one or more installation lines using a tensioning means affixed to platform, such that the platform is moved from a floating configuration in which the platform substantially floats on the body of water to a submerged configuration in which the platform is partially submerged in the body of water; and

detaching the tensioning means from the platform.

In some embodiments, the method may further comprise, after applying the tension, affixing one or more permanent mooring tendons between the platform and the corresponding anchor. Such embodiments preferably further comprise, after affixing the one or more permanent mooring lines, removing the one or more installation lines. In some embodiments, the permanent mooring tendons may be rigid and of fixed length, said length determining the operating depth of the platform. In other embodiments the operating depth may be adjustable. In preferable embodiments, in the submerged configuration, the tensioning means remains at least partially above the surface of the body of water. In some preferable embodiments, the tensioning means remains wholly above the surface of the body of water.

The method may further comprise the step of: affixing a power cable to the platform. The power cable is preferably arranged to transfer useful electrical energy from the platform to a remote storage device or plant.

It will appreciated that the tensioning means may be any suitable tensioning means as described herein, and is preferably a unidirectional mechanism in accordance with the [present disclosure. In some embodiments, the method further comprises: moving a second said platform along a surface of a body of water to a desired deployment location; and affixing the detached tensioning means to the second platform, before carrying out the additional steps of the method on the second platform. In such a way, the same tensioning means may be used to quickly, easily and safely deploy a farm of said platforms, which may form, for example, and offshore windfarm.

It will be appreciated that any features described herein as being suitable for incorporation into one or more aspects or embodiments of the present disclosure are intended to be generalizable across any and all aspects and embodiments of the present disclosure. Other aspects of the present disclosure can be understood by those skilled in the art in light of the description, the claims, and the drawings of the present disclosure. The foregoing general description and the following detailed description are exemplary and explanatory only and are not restrictive of the claims.

### BRIEF DESCRIPTION OF THE DRAWINGS

The accompanying drawings, which are incorporated in and constitute a part of the specification, illustrate embodiments of the disclosure and together with the detailed description herein, serve to explain the principles of the disclosure. The drawings are only for purposes of illustrating preferred embodiments and are not to be construed as limiting the disclosure. It is emphasized that, in accordance with the standard practice in the industry, various features are not drawn to scale. In fact, the dimensions of the various features may be arbitrarily increased or reduced for clarity of discussion. The foregoing and other objects, features and advantages of the disclosure are apparent from the following detailed description taken in conjunction with the accompanying drawings in which:

FIG. 1 depicts an offshore platform in accordance with the present disclosure, where the offshore platform is in use and in the deployed configuration, in accordance with an aspect of the present disclosure;

FIGS. 2A-C illustrate a close up view of a tensioning means of the platform of FIG. 1, in accordance with an aspect of the present disclosure;

FIGS. 3A-F show a stepwise procedure in which the offshore platform of FIG. 1 is deployed, in accordance with an aspect of the present disclosure;

FIG. 4 illustrates a close-up view of a reciprocating unidirectional mechanism in accordance with an aspect of the disclosure;

FIG. 5 illustrates a cutaway view of a structural element of a top portion of the platform, arranged to store a portion of one or more mooring lines of the platform in use, in accordance with an aspect of the present disclosure;

FIG. 6 illustrates the offshore platform of FIG. 1 in use in the deployed configuration, wherein the reciprocating unidirectional mechanism of FIG. 4 is being removed from the platform, in accordance with an aspect of the present disclosure;

FIG. 7 illustrates a close-up view of the unidirectional mechanism during the removal process occurring in FIG. 6, in accordance with an aspect of the present disclosure;

FIG. 8 shows a flow chart depicting the steps of an example embodiment of a method of deploying a buoyant offshore platform for supporting a renewable energy system in accordance with an aspect of the disclosure;

FIG. 9 shows an alternate embodiment of a platform of the first aspect comprising a unidirectional mechanism of the second aspect, in accordance with an aspect of the present disclosure;

FIG. 10 shows a close-up perspective view of the embodiment of FIG. 9, in accordance with an aspect of the present disclosure;

FIG. 11 shows a side view of the embodiment of FIG. 9 transitioning from the floating configuration to the deployed configuration, in accordance with an aspect of the present disclosure;

FIGS. 12A-C depict a first step in an installation sequence in accordance with an aspect of the present disclosure, wherein the platform of FIG. 11 is deployed to desired deployment location and temporarily affixed to the bed of the body of water via anchors, in accordance with an aspect of the present disclosure;

FIGS. 13A-D depict a further step in the installation sequence of FIGS. 12A-C, wherein the platform is transitioned to an operating depth in the submerged configuration and permanently moored to the bed of the body of water at the operating depth via the anchors, in accordance with an aspect of the present disclosure;

FIGS. 14A and 14B depict a further step in the installation sequence of FIGS. 12A-C, wherein the temporary fixings are removed, in accordance with an aspect of the present disclosure;

FIGS. 15A and 15B depict a further step in the installation sequence of FIGS. 12A-C, wherein a submerged power cable is affixed to the platform, in accordance with an aspect of the present disclosure; and

FIGS. 16A and 16B provide close-up isometric views of the platform of FIGS. 12A-15B in the submerged configuration and during maintenance, in accordance with an aspect of the present disclosure.

### DETAILED DESCRIPTION FOR CARRYING OUT THE INVENTION

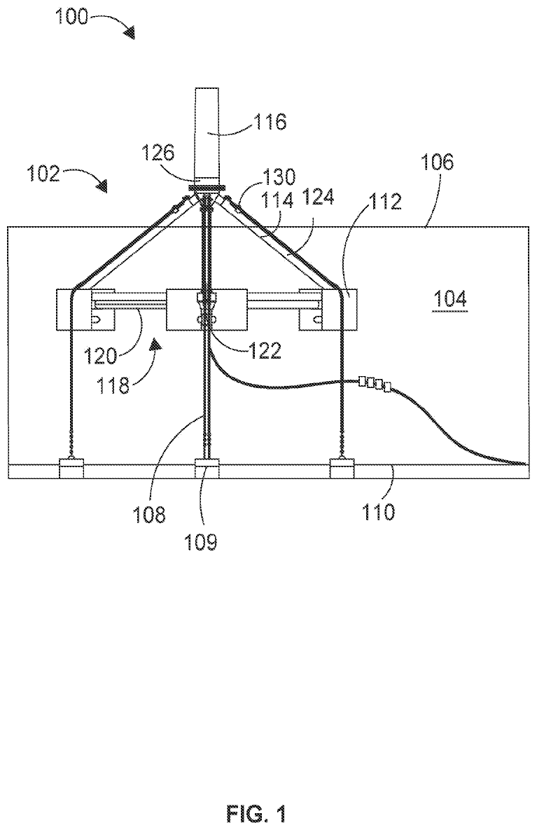

FIG. 1 of the drawings depicts an example embodiment 100 of a buoyant offshore platform 102 in accordance with an aspect of the present disclosure, in a deployed or in-use configuration. In the in-use or deployed configuration shown, the offshore platform 102 is partially submerged within a body of water 104. The position of the offshore platform 102 beneath a surface 106 of the body of water 104 is controlled by a plurality of mooring lines 108, which each couple the offshore platform 102 to a corresponding anchor point 109 positioned in communication with a bed 110 of the body of water 104. A buoyancy of offshore platform 102, provided by a plurality of buoyancy tanks 112 thereof, acts against a tensioning force provided by the mooring lines 108 such that platform 102 is stable in the submerged configuration shown.

The offshore platform 102 comprises an open framework 114 supported on buoyancy tanks 112. In the embodiment 100 shown, the offshore platform 102 is for supporting a renewable energy system and, in particular, for supporting a wind turbine 116. Other embodiments of an offshore platform 102 in accordance with the present disclosure for supporting other suitable pieces of equipment are envisaged.

The open framework 114 may take on a number of possible forms, provided that in such forms, resistance to movement of a medium, such as water or air, is minimised. Examples of such an open framework 114 may include, for instance, a lattice frame, a reticulated frame, a perforated frame, a foraminous frame, a porous frame, a penetrable frame, and/or a skeletal frame.

In this embodiment 100, the open framework 114 has a shape which substantially resembles a triangle-based pyramid or tetrahedron. A base 118 of the open framework 114 is partly formed from three edge structural members 120 which extend along the edges of a triangle. The three edge structural members 120 meet at three vertices 122 at the corners of the triangular base 118. Positioned at each of the three vertices 122 is a corresponding pair of buoyancy tanks 112, cooperating to provide a centre of buoyancy at the corresponding said vertex 122.

The open framework 114 further comprises three angled structural members 124 which each extending from a said vertex 122 of the base 118, towards an upper portion taking the form of a support platform 126 located at an apex of the triangle-based pyramid open framework 114 and supported by the three angled structural members 124.

The open framework 114 further comprises a vertical structural member (not shown) which extends perpendicularly from the underside of the support platform 126 to the base 118, where it is supported by three horizontal structural members (not shown) which each extend from a corresponding said vertex 122 to a centre of the base 118. The stability of the platform 102 126 and structural integrity is provided by this open framework structure, such that the support platform 126 is arranged to support the wind turbine 116.

The buoyancy tanks 112 may take on a number of possible forms, providing that in such forms, the buoyancy tanks 112 provide sufficient buoyancy to the offshore platform 102 such that the offshore platform 102 floats on the surface 106 of a body of water 104 when not in the deployed or in-use configuration shown, i.e. coupled by the mooring lines 108 to the bed 110.

The support platform 126 is supported at the apex on the open framework 114 by the three angled structural members 124 and the vertical structural member. In this embodiment, the support platform 126 comprises a socket (not shown) for accepting and retaining the tower of the wind turbine 116. Other embodiments with different features located on the support platform 126 are envisaged. Additionally, embodiments with any suitable number of angled structural members and/or vertical structural members, each taking any suitable form, will be envisaged.

In the deployed or in-use configuration shown, the offshore platform 102 is tethered to the bed 110 of the body of water 104 by six mooring lines 108. The mooring lines 108 are positioned in pairs, each pair extending from their corresponding anchor point 109 to a vertex 122 of the platform 102. From the vertex 122, the mooring line pair extends along a corresponding angled structural member 124 and is affixed to the platform by way of a corresponding tensioning means 130.

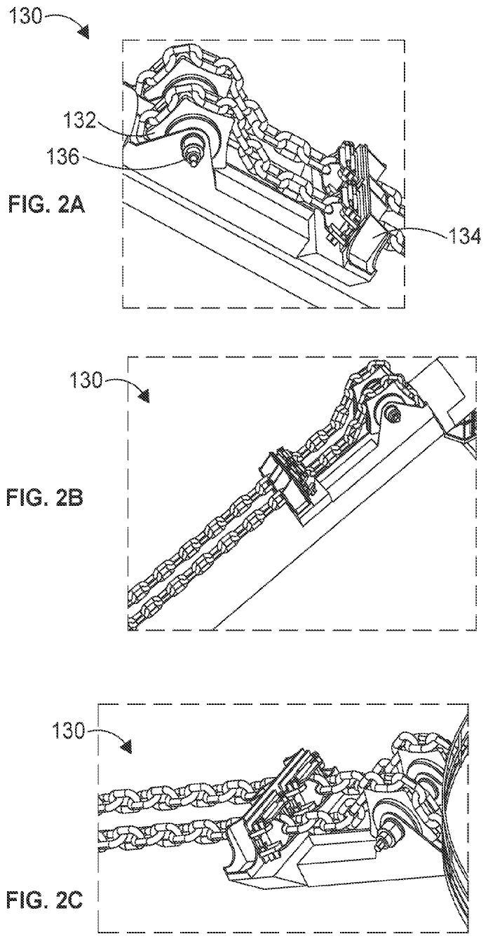

Referring now to FIG. 2A to FIG. 2C, a close-up view of the tension means 130 is shown. The tensioning means 130 comprises a chain pulley 132 and a static unidirectional chain stopper 134. In the embodiment shown, the pulley 132 and the chain stopper 134 are permanently affixed to an upper portion of the corresponding angled structural member 124. The pulley 132 is configured to be driven by a motor 136, which in the embodiment shown is removable. Each tensioning means 130 comprises a pulley 132 and chain stopper 134 as shown and each such means 130 are arranged to apply a first tensioning force to a corresponding pair of said mooring lines 108 when the pulley 132 is driven by a motor 136. The chain stopper 134 comprises a release mechanism which in the example embodiment shown comprises hydraulic rams each arranged to move a corresponding pawl member of the chain stopper from a closed position, in which the corresponding mooring line is permitted to move only in a single direction toward the pulley, to an open position in which the corresponding mooring line is free to move in any direction. The chain stopper 134 in the embodiment 100 shown is therefore arranged to restrict movement of one of the corresponding pair of mooring lines 108 independent of the other of the pair of mooring lines 108. Embodiments will be appreciated wherein the pawl members of the chain stopper 134 may be moved between the open position and the closed position by any suitable mechanism.

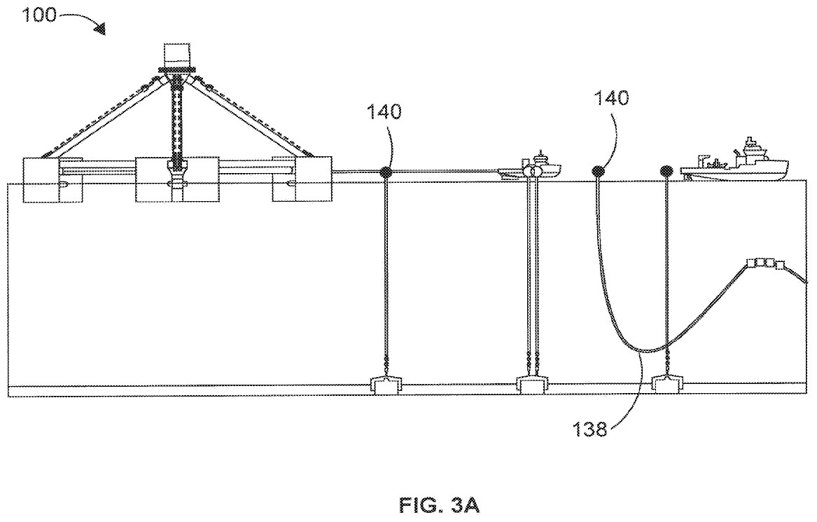

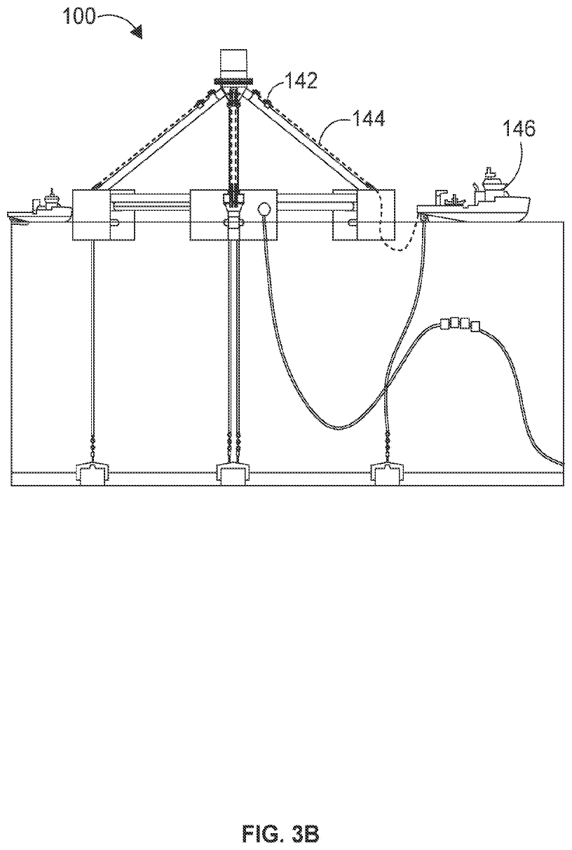

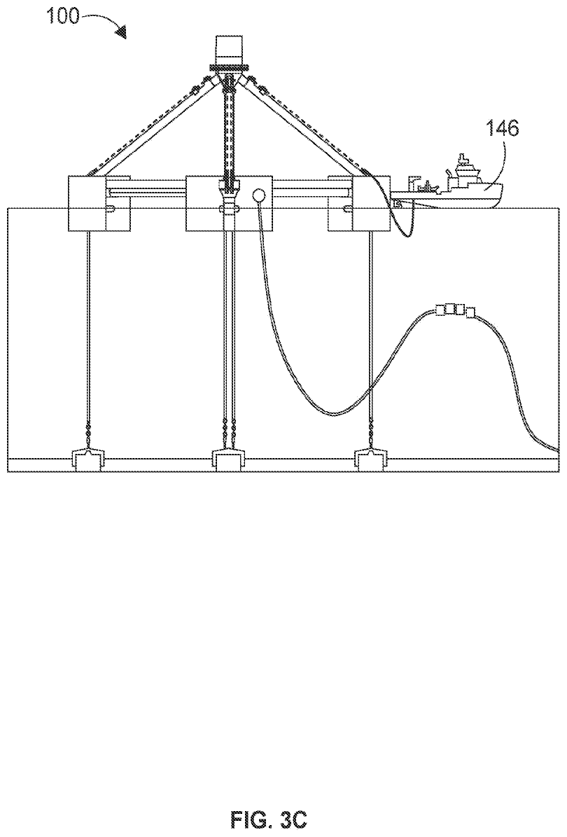

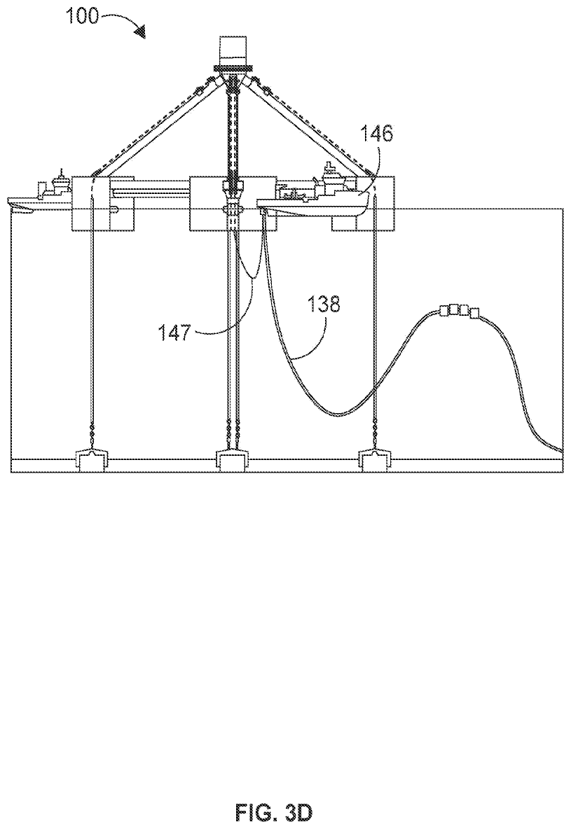

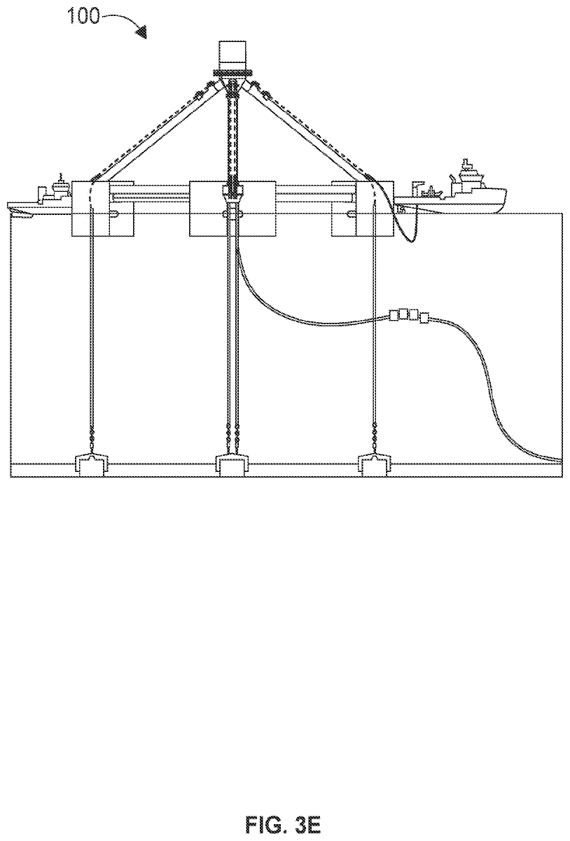

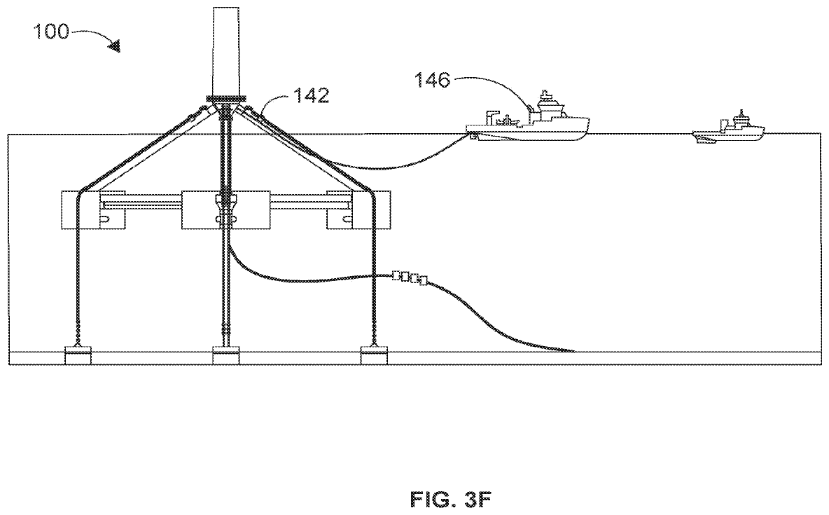

Referring to FIGS. 3A-G, a stepwise deployment process is depicted for deploying the platform of FIG. 1.

In the configuration depicted in FIG. 3A, the six mooring lines 108 are preinstalled at the desired deployment location, each said mooring line affixed to a corresponding anchor point 109 on the bed 110 of the body of water 104. At an end distal to the anchor point 109, the mooring lines each comprise a pennant buoy 140 temporarily affixed thereto, the buoy 140 marking the location of the corresponding mooring line 108. In addition to the mooring lines 109, a power cable 138 is positioned proximate the desired location, the power cable 138 also having a pennant buoy 140 temporarily affixed thereto. In use, the power cable 138 is affixed to a renewable energy capturing device, which in the presently depicted embodiment is a wind turbine 116, such that electrical energy output by the renewable energy capturing device may be transmitted away from the platform 102 to be used. Mooring lines and array cable are pre-installed at site and marked with pennant buoys. The offshore platform 102 is then towed to the desired location, as the platform 102 floats on the surface 106 of the body of water 104 as previously described.

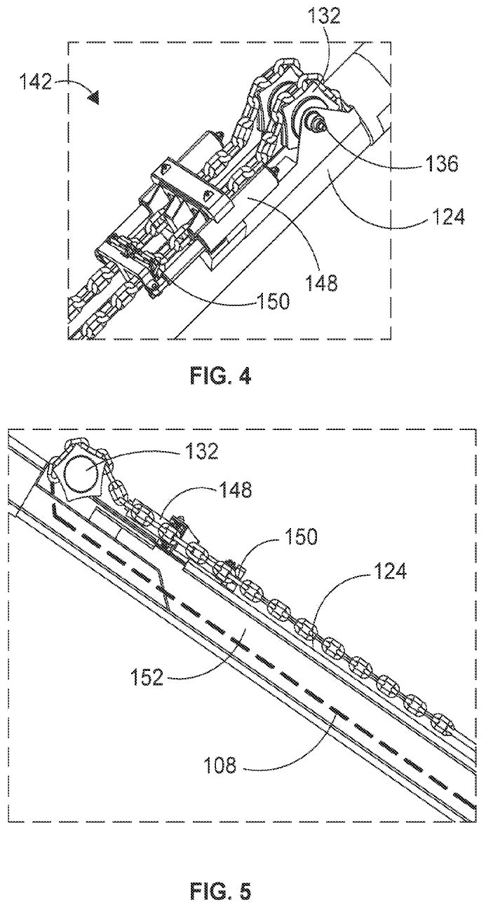

Referring to FIG. 3B, a deployment step subsequent to that depicted in FIG. 3A is shown. In the step shown, a reciprocating unidirectional mechanism 142 is positioned on the platform proximate each of said tensioning means 130. In the embodiment shown, the reciprocating unidirectional mechanism 142 (as described in relation to FIG. 4) takes the form of a chain jack, but other suitable mechanisms are contemplated and as described herein. A single pilot line 144 extending from each tensioning means 130 of the platform 102 is affixed to each mooring line 108 in turn. Subsequent to this step, and as shown FIG. 3C, the motor 136 of each pulley 132 is actuated such that the pulley applies a first tensioning force to each said mooring line 108 affixed thereto, such pre-tensioning being used to pull each said mooring line 108 taut. The pulley 132 is arranged to direct excess mooring line 108 to a mooring line storage compartment 152 (depicted in FIG. 5) located in each of said angled structural members 124. Powering of the motor 136 is performed by a deployment vessel 146, but embodiments will be appreciated wherein any suitable powering means is used. Subsequently, and as depicted in FIG. 3D, the power cable 138 is affixed to a corresponding pilot line 147, before being hoisted into engagement with a power socket (not shown) on-board the platform, using the deployment vessel 146 as shown in FIG. 3E.

FIG. 3F shows a deployment step subsequent to that depicted in FIG. 3E, in which the reciprocating unidirectional mechanisms 142 are engaged with each corresponding mooring line 108 pair, and while powered by the deployment vessel 146, provide a second tensioning force to each said mooring line 108 such that the platform 102 is partially submerged in the body of water 104 at the deployed or in-use configuration. The reciprocating unidirectional mechanisms 142 reciprocate in order to apply the second tensioning force in a cyclic manner. The use of such a mechanism to apply the second tensioning force in this manner to two mooring lines simultaneously preferably provides an efficient deployment means. The ability to apply the second tensioning force to each line of the pair of the mooring lines independently of the other preferably provides the required flexibility and redundancy during deployment, which can often be in a remote location where access to the platform to overcome issues during deployment may be restricted.

Referring to FIG. 4, a close-up view of a reciprocating unidirectional mechanism 142 is shown in accordance with an aspect of the present disclosure, and as described in relation to the deployment process depicted in FIGS. 3A-F. The mechanism 142 shown is suitable for inclusion in a kit of parts in accordance with a further aspect. The reciprocating unidirectional mechanism 142 comprises a pair of hydraulic rams 148 each arranged to move a corresponding moveable chain stopper 150 in a reciprocating manner. As described previously, the hydraulic rams 148 of the mechanism 142 may be operated independently in order to move the corresponding chain stopper 150 independently of the other. The chain stoppers 150 each comprise a release mechanism which, in the embodiment shown, comprises a hydraulic ram arranged to move a corresponding pawl member of the respective chain stopper 150. The release mechanism is arranged to switch the mechanism 142 from a tensioning mode wherein movement of the mooring line is restricted to a direction toward the pulley, and a release mode in which free movement of the mooring line is permitted.

Referring to FIG. 5, as previously described herein, the pulley 132 of a tensioning means 130 is arranged to direct excess mooring 108 line into a cavity or compartment within the platform, which in the example shown is a mooring line storage compartment 152 located within a hollow section of each angled structural member 124. Such a storage compartment preferably improves the safety of a platform, wherein excess slack mooring line may pose a hazard to deployment or maintenance crew.

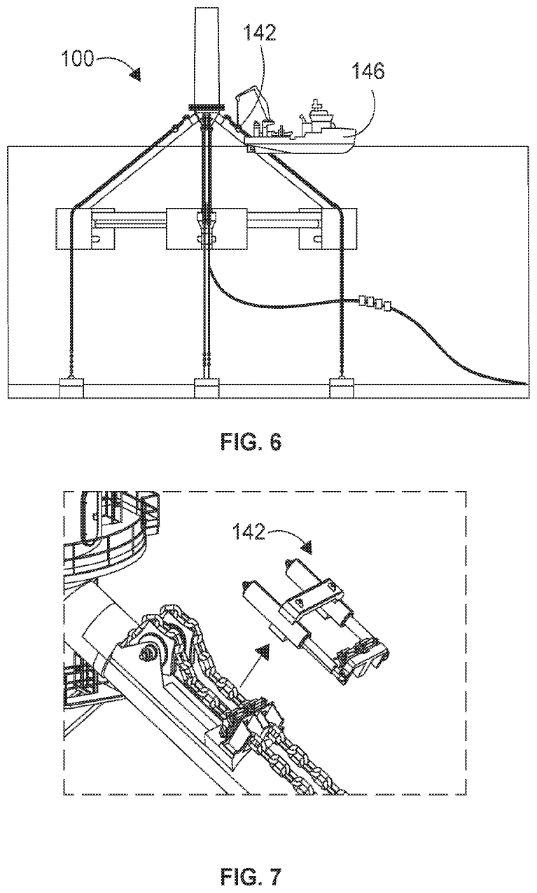

Referring to FIG. 6, a final example deployment step is depicted in which the reciprocating unidirectional mechanisms 146 are each sequentially removed from the platform 102 by the deployment vessel 146, more closely shown in FIG. 7. The detachable nature of the mechanism 142 preferably aids in deployment of several such platforms within a short space of time, which can be beneficial during fluctuating weather patterns which would otherwise pose a risk to deployment vessels and crew members.

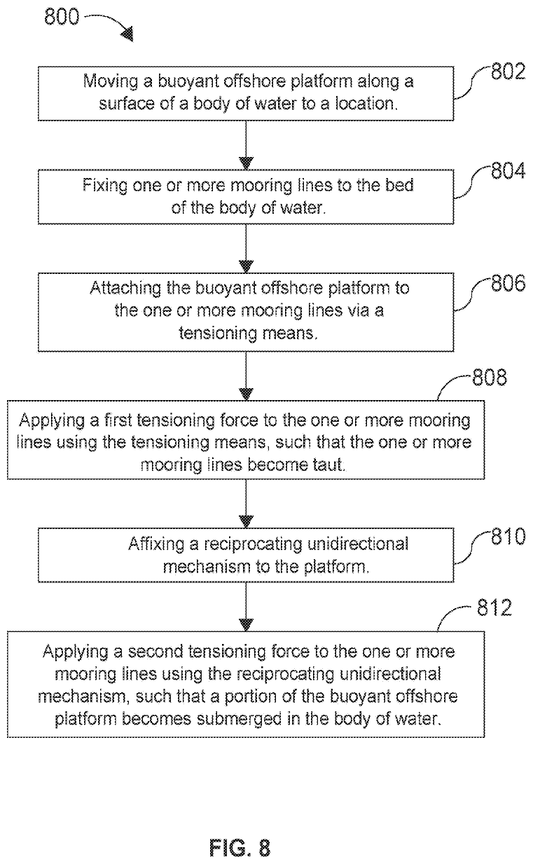

Referring to FIG. 8, steps of an example method 800 in accordance with an aspect of the present disclosure are shown by way of a flowchart. In the embodiment 800, the method may comprise the steps of:

moving a buoyant offshore platform along a surface of a body of water to a location 802;

fixing one or more mooring lines to the bed of the body of water 804;

attaching the buoyant offshore platform to the one or more mooring lines via a tensioning means 806;

applying a first tensioning force to the one or more mooring lines using the tensioning means, such that the one or more mooring lines become taut 808;

affixing a reciprocating unidirectional mechanism to the platform 810;

applying a second tensioning force to the one or more mooring lines using the reciprocating unidirectional mechanism, such that a portion of the buoyant offshore platform becomes submerged in the body of water 812.

It will be appreciated that the method 800 may be performed using a platform, reciprocating unidirectional mechanism, and/or kit of parts as described herein.

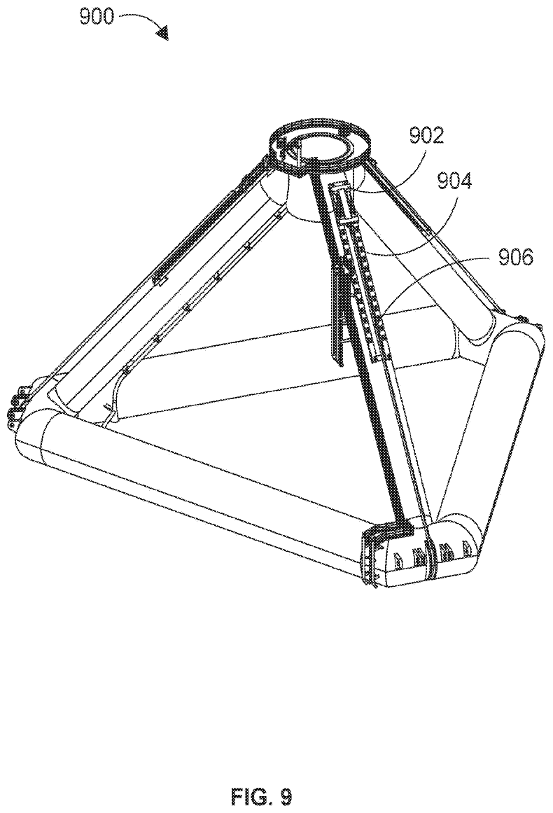

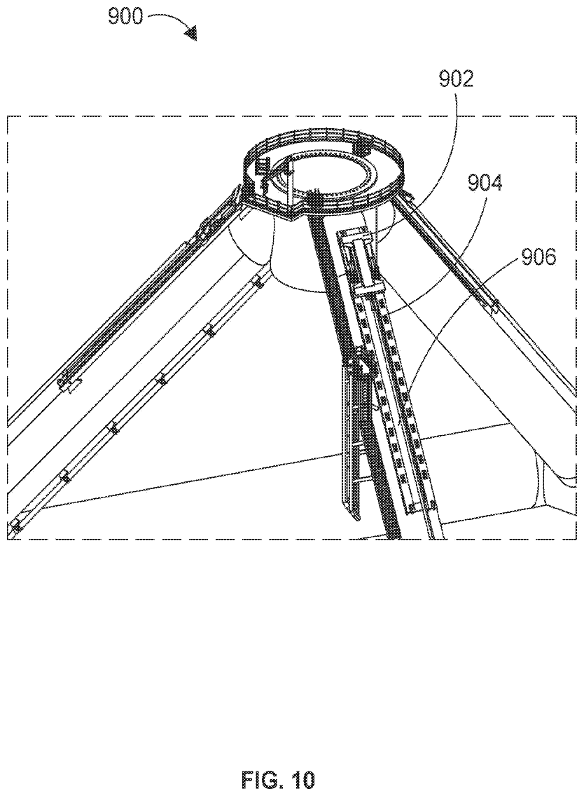

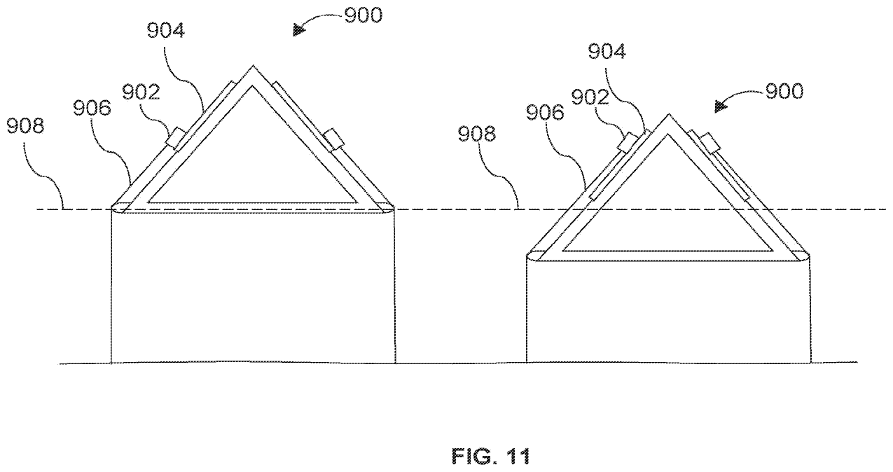

FIG. 9 shows an alternate embodiment of a platform 900 in accordance with the first aspect, the platform substantially as described previously but wherein the tensioning means further comprises a rail 904 to which the reciprocating unidirectional mechanisms 902 are affixed. The reciprocating unidirectional mechanisms 902 are arranged to move along the rail 904 during a tensioning mode thereof, in order to apply tension to, or release tension from, the mooring lines 906. The rail 904 in the embodiment shown is an indexed or slotted rail, as seen more closely in FIG. 10, having slots or grooves arranged to be engaged by the reciprocating unidirectional mechanism 902 in order to prevent further movement thereof, for example under tension of the mooring lines 906. The embodiment of FIG. 9 is shown in-use in FIG. 11, with the left-hand view depicting the platform 900 in the floating configuration. In said floating configuration, the reciprocating unidirectional mechanism 902 is arranged to initiate a tensioning mode thereof, during which movement of the mooring lines 904 through the unidirectional mechanism 902 is inhibited. During the tensioning mode the unidirectional mechanism 902 is further arranged to move along the rail in order to apply tension to the mooring lines 904, and further to force the platform 900 to transition from the floating configuration shown in the left view to the deployed configuration shown in the right view of FIG. 11 During said transition, the base of the platform 900 is submerged beneath the surface of the body of water 908. In use, following the transition to the deployed configuration, the rail 904 and the reciprocating unidirectional mechanism 902 are removed from the platform 900 in order to be reused in the deployment of a subsequent platform (not shown). Prior to removal, the mooring lines may be affixed to the platform such that their length remains fixed, or a static unidirectional mechanism of the platform may inhibit further lengthening of the mooring lines. Embodiments will be appreciated wherein the rail and the reciprocating unidirectional mechanism remain affixed to the platform.

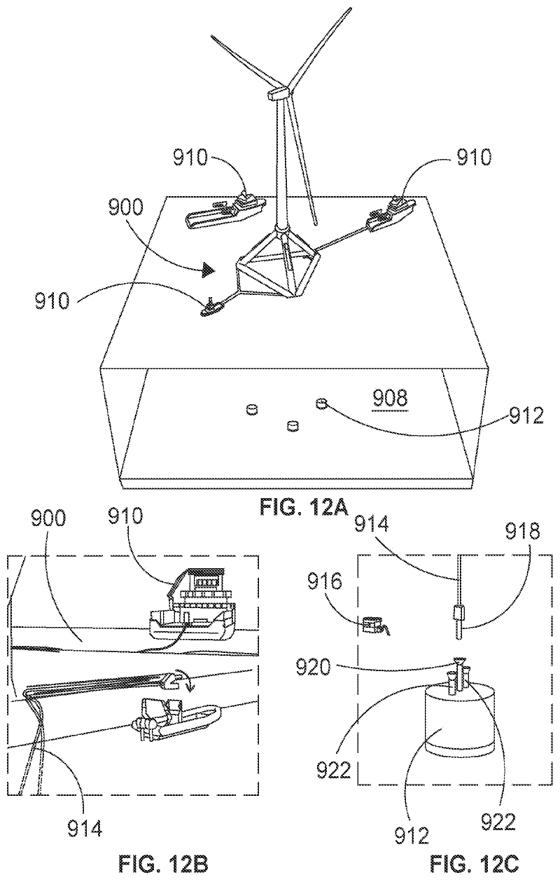

FIGS. 12A to 15B detail an installation sequence in accordance with the present invention. For exemplary purposes the installation sequence is represented using the platform embodiment 900 as detailed in relation to FIG. 9, but embodiments will be appreciated, wherein the installation sequence is suitable for implementation with any platform or unidirectional mechanism as described herein.

FIGS. 12A-C depict an initial step in the installation sequence, wherein the platform 900 is deployed to an appropriate deployment location using deployment vessels 910 to tow the platform 900 across the surface of the body of water 908. Once located at the desired deployment location, the platform 900 is positioned with each of the three vertices of the triangular platform base portion positioned over a corresponding pre-deployed anchor 912, each of the three pre-deployed anchors 912 pre-positioned in engagement with the bed of the body of water. Installation lines 914 are connected to the platform 900 at one end thereof, with a second end thereof lowered from the platform 900 toward a corresponding anchor 912. A remotely-operated underwater vehicle (ROV) 916 is deployed by a deployment vessel 910, the ROV 916 arranged to facilitate an engagement between the second end of the installation lines 914 and the corresponding anchor 912. In the example embodiment shown in FIG. 12C, the second end of the installation lines 914 comprises a connector 918 shaped to engage a corresponding central connector 920 located on the anchor 912. In the example embodiment shown, the installation line connector 918 and the anchor connector 920 comprises a subsea mooring connector (SMC) such as a Ballgrab® connector. Embodiments will be appreciated wherein any suitable connector is used to affix the installation lines 914 to a corresponding anchor 912, either temporarily or permanently. As shown, the installation lines 914 are affixed to the platform 900 and the anchor 912 in a temporary manner.

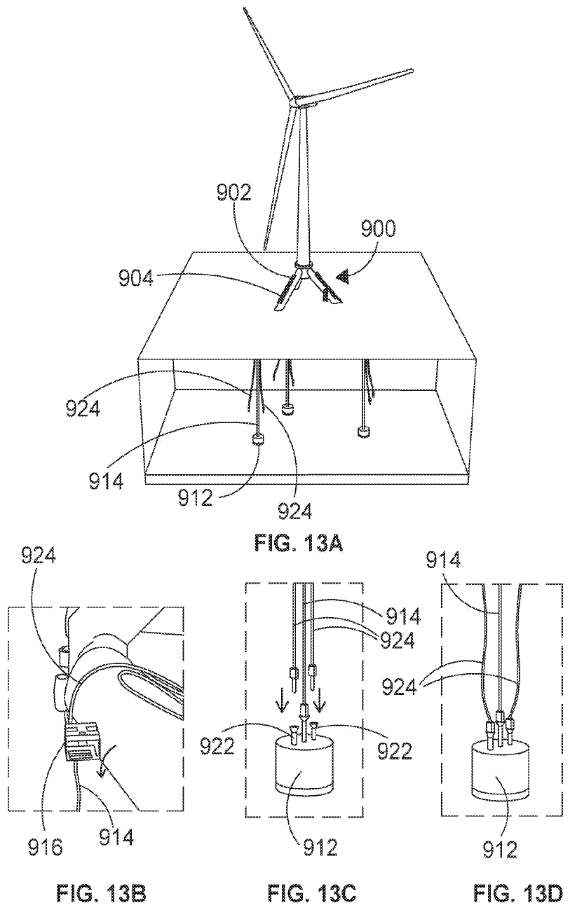

As shown in FIG. 12C, the anchors 912 comprise two further connectors 922 positioned either side of the central connector 920. These two further connectors 922 are each arranged to engage a connector of a second end of a permanent mooring tendon connecting the anchor 912 to the platform 900 as described in relation to FIGS. 13A-D.

With reference to FIGS. 13A-D, a further step in the installation sequence is depicted in which a tension is applied to the installation lines 914 as described herein using the unidirectional mechanism 902 and rail 904, in order to transition the platform 900 from the floating configuration shown in FIGS. 11 and 12A to the submerged configuration shown in FIGS. 11 and 13A. Any mode of tensioning using any suitable tensioning means described herein may be used. Once at the desired operating depth of the submerged configuration, an ROV 916 is used to facilitate the engagement of permanent mooring tendons 924, extending from the platform, to the corresponding further connectors 922 of a corresponding anchor 912 as shown in FIGS. 13C-D. Any suitable connector may be used, including a suitable subsea mooring connector (SMC) such as a Ballgrab® connector. As shown, the permanent mooring tendons 924 define a fixed operating depth of the platform 900, determining by the fixed length of the mooring tendons 924. Other alternative embodiments would be appreciated, wherein the operating depth may be adjusted by extending or withdrawing a portion of the mooring tendons between the platform 900 and the corresponding anchor 912, such as using a winch and/or a presently described tensioning means.

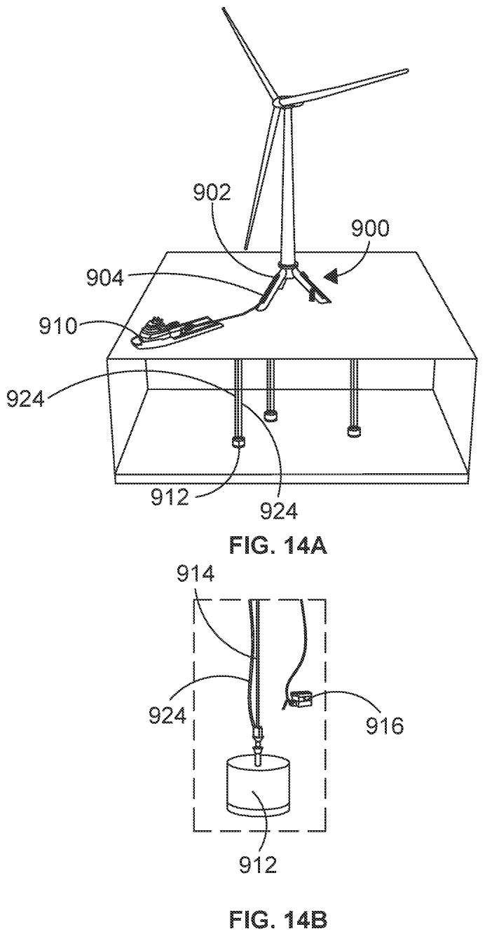

Referring now to FIGS. 14A and B, a further step in the installation sequence is depicted, the step comprising operating the tensioning means 902 by the deployment vessel 910 as shown in FIG. 14A to release tension from the installation lines 914 such that the permanent mooring tendons 924 alone bear all of the tension applied thereon by the buoyant platform 900. The platform 900 is then supported at the operating depth in the submerged configuration by the mooring tendons 924, said operating depth in the example shown determined by the length of the mooring tendons 924. The second end of the installation lines 914 are disengaged from the corresponding anchor 912 as shown in FIG. 14B, either remotely or using the ROV 916. The temporary installation lines 914 are then recovered by the deployment vessel 910. In the example shown, the tensioning means comprising the unidirectional mechanism 902 is also recovered by the deployment vessel 910 for use in deploying a further platform. In the example shown, the rail 904 is also recovered by the deployment vessel 910 for re-use in installing a further platform.

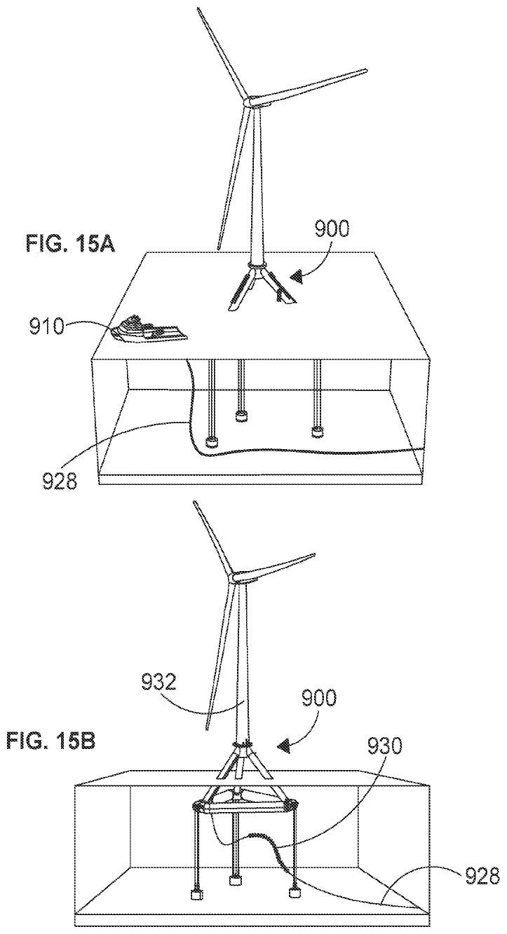

FIGS. 15A and B depict a further step in the installation sequence that involves the affixing of a subsea power cable 928 to the platform 900 for transmission of electrical energy from the platform 900. The cable 928 is laid towards the platform 900 as shown in FIG. 15A, and cable ancillary equipment is affixed to the cable 928, including buoyancy modules and bend stiffeners 930, to stabilise the cable 928 in the body of water. A messenger line (not shown) through a J-tube is connected to the cable 928 from a winch (not shown) located on the platform 900, and the winch then pulls the cable 928 into position for connecting to a corresponding port on the platform 900. The turbine 932 is ten commissioned to provide a completed deployed platform as shown in FIG. 15B.

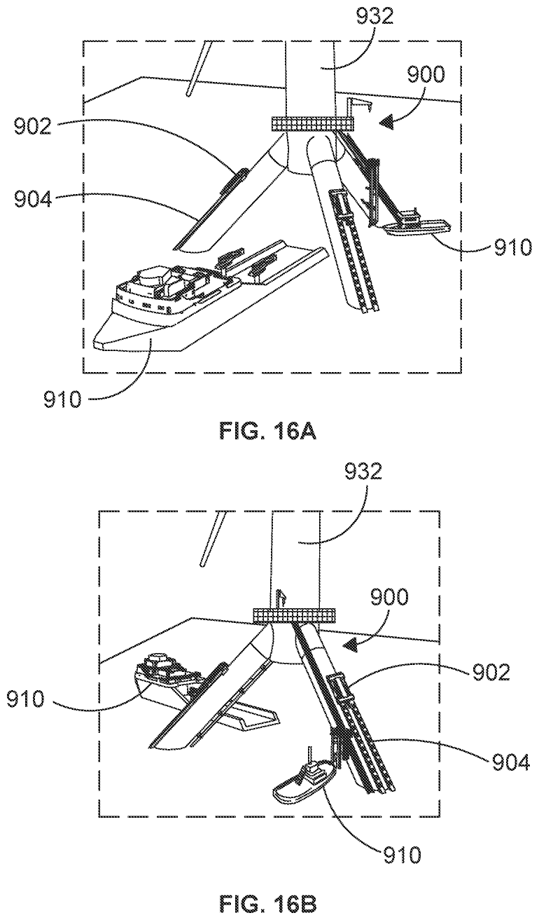

FIGS. 16A and B show close-up isometric views of the platform 900 following the tensioning step using the tensioning means 902, 904 and prior to removal of the tensioning means 902, 904 by the deployment vessels 910. As shown in FIGS. 16A and B, the platform 900 in the example described is compatible with existing maintenance options, providing access to crew transfer vessels (CTV) via boat landing and ladders on the diagonal braces of the platform 900. A region under the top portion of the platform 900 supporting the turbine 932 is provided which remains above the surface of the body of water in the submerged configuration. This region, in the example shown in FIGS. 16A and B has an example suitable draft of greater than or equal to 18m and an example suitable height of greater than or equal to 10m to provide room for service operation vessels (SOV) or larger vessels to tend to the platform and turbine during installation and maintenance. The stability of the platform 900 in the submerged operating configuration caused by the buoyancy of the platform 900 and resultant tension in the mooring tendons 924 results in low motion in this configuration and provides compatibility with walk to work and heave compensated crane access systems. Back to port maintenance is facilitated by a simple re-attachment of the tensioning means and deployment system, and therefore a simple reversal of the installation and deployment process described herein.

It will be appreciated that the above described embodiments are given as examples only and that alternatives are also considered within the scope of the disclosure. For example the construction details can be any shape or size, or any suitable material. The numbers of mooring lines, platform vertices and any other details can be varied and the tensioning options can be of any suitable means. The mooring lines in the depicted examples are chains, and as such the tensioning means depicted are primarily suited to chains. Other embodiments are contemplated, wherein the mooring lines take any suitable form, such as for example a natural or synthetic rope as described herein.

As may be recognized by those of ordinary skill in the art based on the teachings herein, numerous changes and modifications may be made to the above-described and other embodiments of the present disclosure without departing from the scope of the disclosure. The components of the buoyant offshore platform as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the buoyant offshore platform may include more or fewer components or features than the embodiments as described and illustrated herein. Further, the steps of the method of deploying an offshore platform for supporting renewable energy systems may be used interchangeably and in alternative combinations as would be modified or altered by one of skill in the art. Accordingly, this detailed description of the currently-preferred embodiments is to be taken in an illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or structure that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

What is claimed is:

1. A buoyant offshore platform for supporting a renewable energy system in a body of water having a surface and a bed, said buoyant offshore platform comprising:
a base portion for submerging below said surface of said body of water;
a top portion for remaining above said surface of said body of water;
at least one mooring line for fixing the buoyant offshore platform to said bed of said body of water; and
a tensioning means for applying tension to the one or more mooring lines;
wherein the buoyant offshore platform further comprises a floating configuration in which the buoyant offshore platform is positioned substantially floating on said surface of said body of water;
wherein the buoyant offshore platform comprises a deployed configuration in which the base portion is submerged beneath said surface of said body of water and the top portion remains above said surface of said body of water; and
wherein, in use, the tensioning means is arranged to apply tension to the one or more mooring lines fixed between the buoyant offshore platform and said bed of said body of water such that the buoyant offshore platform transitions between the floating configuration and the deployed configuration.

2. The buoyant offshore platform of claim 1, wherein the tensioning means comprises a pulley affixed to the platform, the pulley arranged to be driven by a drive means, and further arranged to apply a first tensioning force to the at least one mooring line when driven by the drive means.

3. The buoyant offshore platform of claim 2, wherein said tensioning means is arranged to apply the first tensioning force to two of the at least one mooring lines.

4. The buoyant offshore platform of claim 2, wherein the platform further comprises a mooring line storage compartment, and wherein the pulley is further arranged to direct the at least one mooring lines into the mooring line storage compartment.

5. The buoyant offshore platform of claim 4, wherein the mooring line storage compartment is located within a hollow structural element of the top portion.

6. The buoyant offshore platform of claim 2, wherein the pulley is permanently affixed to the platform.

7. The buoyant offshore platform of claim 2, wherein the drive means is a motor, and wherein the motor is in removable engagement with the pulley.

8. The buoyant offshore platform of claim 1, wherein the tensioning means further comprises a static unidirectional mechanism having a tensioning mode in which the unidirectional mechanism is arranged to restrict movement of the at least one mooring lines to a single direction; and
a release mode in which the unidirectional mechanism is arranged to permit free movement of the at least one mooring lines in any direction.

9. The buoyant offshore platform of claim 8, wherein the static unidirectional mechanism is permanently affixed to the platform such that the static unidirectional mechanism is immovable relative to the platform.

10. The buoyant offshore platform of claim 1, wherein the tensioning means further comprises a reciprocating unidirectional mechanism, the reciprocating unidirectional mechanism comprising:
a first hydraulic ram and a second hydraulic ram,
each of said first and second hydraulic rams are affixed to a corresponding moveable unidirectional member having:
a tensioning mode in which the unidirectional member is arranged to restrict movement of the at least one mooring lines to a first direction, and further arranged to be moved by the corresponding hydraulic ram in the first direction to apply a second tensioning force to the mooring lines; and
a release mode in which the unidirectional member is arranged to be moved along the mooring line in a second direction opposing the first direction by the corresponding hydraulic ram;
wherein each unidirectional member is arranged to transition between the tensioning mode and the release mode in a reciprocating manner.

11. The buoyant offshore platform of claim 10, wherein each unidirectional member may be moved by the corresponding first or second hydraulic ram independently of the other unidirectional member.

12. The buoyant offshore platform of claim 10, wherein the at least one mooring lines comprise a chain, and wherein the reciprocating unidirectional mechanism is a chain jack.

13. The buoyant offshore platform of claim 10, wherein the reciprocating unidirectional mechanism is removably affixed to the platform.

14. The reciprocating unidirectional mechanism arranged to apply a tensioning force to two of the at least one mooring lines of the platform of claim 1, wherein the unidirectional mechanism comprises:
a first hydraulic ram and a second hydraulic ram,
each of said first and second hydraulic rams affixed to a corresponding moveable unidirectional member having:
a tensioning mode in which the unidirectional member is arranged to restrict movement of at least one mooring line to a first direction, and further arranged to be moved by the corresponding hydraulic ram in the first direction to apply a tensioning force to said at least one mooring line; and
a release mode in which the unidirectional member is arranged to be moved along the at least one mooring line in a second direction opposing the first direction by the corresponding hydraulic ram.

15. The reciprocating unidirectional mechanism of claim 14, wherein the unidirectional mechanism is arranged to apply the tensioning force to two of the at least one mooring lines independently of one another.

16. The reciprocating unidirectional mechanism of claim 14, wherein the reciprocating unidirectional mechanism is a chain jack.

17. A kit comprising:
the buoyant offshore platform of claim 1; and
the reciprocating unidirectional mechanism of claim 14.

18. A method of deploying a buoyant offshore platform for supporting a renewable energy system, the method comprising:
moving a buoyant offshore platform along a surface of a body of water to a location;
fixing at least one mooring line to the bed of the body of water;
attaching the buoyant offshore platform to the at least one mooring line via a tensioning means;
applying a first tensioning force to the at least one mooring line using the tensioning means, such that the at least one mooring line becomes taut;
applying a second tensioning force to the at least one mooring line such that a portion of the buoyant offshore platform becomes submerged in the body of water.

19. The method of claim 18, further comprising:
affixing a reciprocating unidirectional mechanism to the platform;
wherein the second tensioning force is applied using the reciprocating unidirectional mechanism.

20. The method of claim 19, further comprising:
detaching the reciprocating unidirectional mechanism from the platform.
